(19) United States
(12) Patent Application Publication
(10) Pub. No.: US 2009/0056218 A1
(43) Pub. Date: Mar. 5, 2009

(54) COVER FOR A POT FOR PLANTS OR THE LIKE

(75) Inventor: Koenraad Jacobus Broekhuizen, Amstelveen (NL)

Correspondence Address: Muncy, Geissler, Olds & Lowe, PLLC, P.O. BOX 1364, FAIRFAX, VA, 22038-1364, US

(73) Assignee: Koen Pack B.V., Amstelveen (NL)

(21) Appl. No.: 12/201,963

(22) Filed: Aug. 29, 2008

(30) Foreign Application Priority Data
Aug. 29, 2007 (NL) NL1034301

(51) Int. Cl. A01G 9/02

(52) U.S. Cl. 47/72

(57) ABSTRACT

The invention relates to a cover for a pot for plants or the like, which cover is made up of a sheet-like material and which comprises a bottom and a circular side wall extending upwards from said bottom. The cover is combined with a liquid-impermeable tray placed on the bottom of the cover, which tray comprises a bottom plate placed on the bottom of the cover and a circular side wall extending upwards from said bottom plate.

The invention relates to a cover for a pot for plants or the like, which cover is made up of a sheet-like material and which comprises a bottom and a circular side wall extending upwards from said bottom.

Such covers are known, for example from U.S. Pat. Nos. 6,061,958 and 6,385,905.

A problem that occurs when using such covers is that the pots to be placed in said covers, which pots contain plants or the like, are usually not watertight, on the contrary, they are generally provided with a hole in the bottom thereof. Consequently there is a danger that water or the like liquid being administered to a plant present in the pot will flow into the interior of the cover and thus contaminate the interior of the cover. Moreover, such covers are generally made of water-permeable materials, so that also the surface on which the cover with the pot is placed will be contaminated. In addition to that, the moisture flowing into the cover may adversely affect the cover material.

The object of the invention is to provide an embodiment by which the drawback connected to the use of known covers can be eliminated.

According to the invention this object can be accomplished in that the cover is combined with a liquid-impermeable tray placed on the bottom of the cover, which tray comprises a bottom plate placed on the bottom of the cover and a circular side wall extending upwards from said bottom plate.

When using the construction according to the invention, any liquid flowing from the pot containing the plant or the like will be collected in the tray, thus avoiding the above-described drawbacks of the known embodiments.

Preferably, the tray is removably provided in the cover, so that it can be readily placed in the cover and also be readily removed therefrom, if desired.

To conform to the usual pot shapes, the tray is circular in section.

An advantageous embodiment of the cover is obtained if it is built up of parts which are glued or welded together, so that no complicated moulds or the like are required for producing the cover.

The bottom of the cover is provided with a flanged edge, which is attached to the bottom end of the side wall of the cover.

A suitable configuration of the cover can be obtained in a simple manner by forming the circular side wall of the cover of a number of strips of a sheet-like material, which are attached together with overlapping edges.

The invention will be explained in more detail hereinafter with reference to an embodiment of the invention as schematically shown in the appended figures.

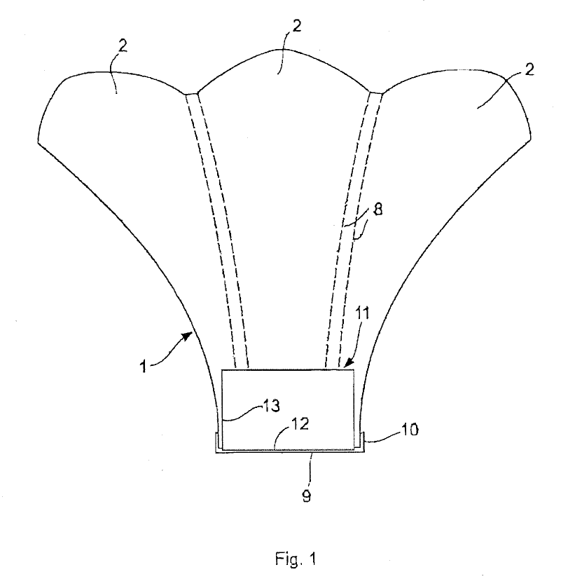

FIG. 1 is a schematic, sectional view of a cover with a tray placed therein.

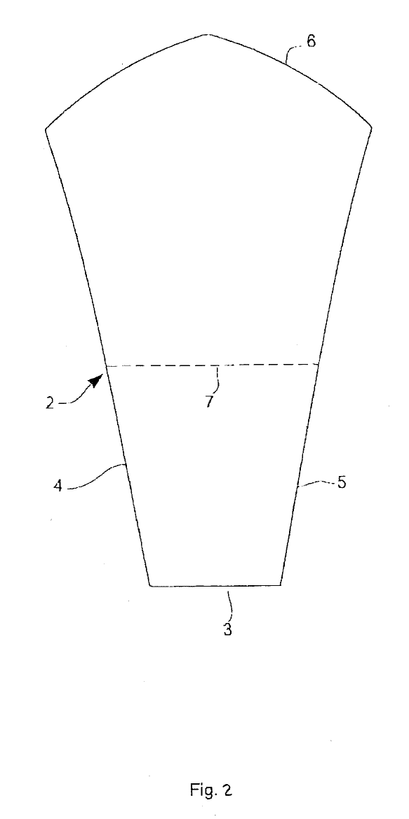

FIG. 2 is a larger-scale view of a strip-shaped, sheet-like part, which is used for forming the cover.

The cover 1 shown in FIG. 1 is built up of a number of strips 2, for example six, of a sheet-like material, for example paper, plastic, a permeable fabric or the like.

As shown in particular in FIG. 2, the width of such a strip-shaped part 2 gradually increases from its bottom end 3, whilst the lateral boundary hedges 4 and 5 may extend rectilinearly or curvilinearly, depending on the desired shape, or, as shown in FIG. 2, rectilinearly along their lower part and curvilinearly outwards along their upper part. The upper boundary edge 6 of the sheet-like part can be given any desired shape, for example a curved shape as shown in FIG. 2.

In the embodiment that is shown in FIG. 2, a fold line 7 is impressed in the material at the transition between the rectilinear portions of the side edges 4 and 5 and the curvilinear portions of the side edges 4 and 5, so that said upper portions of the strips 2 can flare out relative to the lower portions in the assembled condition of the cover.

As illustrated in double dotted lines 8 in FIG. 1, the edges of adjacent strips 2 are attached together, for example by glueing or welding, with a certain overlap.

As FIG. 1 furthermore shows, the cover further has a bottom 9, which is provided with an upright edge 10, which is attached to the outer sides of the bottom ends of the strips 2, for example by glueing or welding.

As will furthermore be apparent from FIG. 1, the cover is combined with a tray 11 placed inside the cover, which tray comprises a bottom plate 12 and a circular side wall 13 being integral with said bottom plate 12, which side wall extends upwards from said bottom plate 12. The bottom plate 12 is supported on the bottom 9 of the cover 1, preferably without being connected thereto, so that the tray 11 can not only be readily placed in the cover but also be readily removed therefrom, if desired.

When using the cover 1 combined with the tray 11, a pot containing a plant or the like can be placed in the tray 11 with its bottom end, so that any moisture draining from the pot can be collected in the tray.

To conform to the usual pot shapes, the tray 13 is preferably circular in section. Also other shapes of the cover and of the tray than those shown in the figures are conceivable, of course.

1. A cover for a pot for plants or the like, which cover is made up of a sheet-like material and which comprises a bottom and a circular side wall extending upwards from said bottom, characterised in that the cover is combined with a liquid-impermeable tray placed on the bottom of the cover, which tray comprises a bottom plate placed on the bottom of the cover and a circular side wall extending upwards from said bottom plate.

2. A cover according to claim 1, characterised in that the tray is removably provided in the cover.

3. A cover according to claim 1, characterised in that the tray is circular in section.

4. A cover according to claim 1, characterised in that the cover is built up of a number of parts which are glued or welded together.

5. A cover according to claim 1, characterised in that the bottom of the cover is provided with a flanged edge, which is attached to the bottom end of the side wall of the cover.

6. A cover according to claim 1, characterised in that the circular side wall of the cover is formed of a number of strips of a sheet-like material, which are attached together with overlapping edges.

7. A cover according to claim 6, characterised in that said strips gradually increase in width from the bottom end towards the upper end.

8. A cover according to claim 6, characterised in that the boundary edges of a strip extend rectilinearly from the bottom end of a strip along part of their length, blending into curvilinear parts extending in directions away from each other.
